(19) United States
(12) Patent Application Publication
(10) Pub. No.: US 2021/0182670 A1
(43) Pub. Date: Jun. 17, 2021

(54) METHOD AND APPARATUS WITH TRAINING VERIFICATION OF NEURAL NETWORK BETWEEN DIFFERENT FRAMEWORKS

(71) Applicant: Samsung Electronics Co., Ltd., Suwon-si (KR)

(72) Inventor: Gyungmin KIM, Seongnam-si (KR)

(73) Assignee: Samsung Electronics Co., Ltd., Suwon-si (KR)

(21) Appl. No.: 16/893,656

(22) Filed: Jun. 5, 2020

(30) Foreign Application Priority Data
Dec. 16, 2019 (KR) 10-2019-0168150

(51) Int. Cl. G06N 3/08; G06N 3/04

(52) U.S. Cl. CPC G06N 3/08; G06N 3/0454

(57) ABSTRACT

A processor-implemented method of verifying the training of a neural network between frameworks is provided. The method includes providing test data to a first module operating based on a first framework, and providing the test data to a second module operating based on a second framework. The method further includes obtaining, from the first module, first data generated in the first module, obtaining, from the second module, second data generated in the second module, and comparing the first data with the second data.

### CROSS-REFERENCE TO RELATED APPLICATIONS

This application claims the benefit under 35 USC § 119(a) of Korean Patent Application No. 10-2019-0168150, filed on Dec. 16, 2019, in the Korean Intellectual Property Office, the entire disclosure of which is incorporated herein by reference for all purposes.

### BACKGROUND

### 1. Field

The following description relates to methods and apparatuses with training verification of neural networks between frameworks.

### 2. Description of Related Art

Neural networks are processor-implemented computing systems which are implemented by referring to a computational architecture.

Neural network devices processing the neural networks, may implement the neural networks based on a framework. Depending on a framework used by a neural network device, training parameters of the neural network may vary, and features that are finally output may vary. In order for a neural network to achieve consistent performance, the verification of the training of the neural network between frameworks may be beneficial.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a processor-implemented method includes providing test data to a first module that implements a first neural network based on a first framework, providing the test data to a second module that implements a second neural network having a same structure as the first neural network based on a second framework, obtaining, from the first module, first data generated from the test data provided to the first module, obtaining, from the second module, second data generated from the test data provided to the second module; and comparing the first data with the second data.

The obtaining of the first data from the first module may include obtaining first input data implemented in an operation of a layer of the first neural network and first output data generated based on the operation of the layer of the first neural network, and the obtaining of the second data from the second module may include obtaining second input data implemented in an operation of a layer of the second neural network and second output data generated based on the operation of the layer of the second neural network.

The comparing of the first data with the second data may include comparing the first input data implemented in the layer of the first neural network with the second input data implemented in the layer of the second neural network corresponding to the layer of the first neural network; and comparing the first output data generated as the result of the operation of the layer of the first neural network with the second output data generated as the result of the operation of the layer of the second neural network corresponding to the layer of the first neural network.

The obtaining the first data from the first module may include obtaining first training parameters learned during the operation of the layer of the first neural network, and the obtaining the second data from the second module may include obtaining second training parameters learned during the operation of the layer of the second neural network.

The comparing of the first data with the second data may include comparing the first training parameters learned during the operation of the layer of the first neural network, with the second training parameters learned during the operation of the layer of the second neural network corresponding to the layer of the first neural network.

The obtaining the first data from the first module may include obtaining first input data implemented in a first sub-operation, which is an operation excluding an operation of a layer of the first neural network from among operations performed by the first module, and first output data output based on the first sub-operation, and the obtaining the second data from the second module may include obtaining second input data implemented in a second sub-operation, which is an operation excluding an operation of a layer of the second neural network from among operations performed by the second module, and second output data output based on the second sub-operation.

Each of the first sub-operation and the second sub-operation may include at least one of a data augmentation operation, an optimization operation, a quantization operation, and a user operation.

The comparing of the first data with the second data may include comparing the first input data implemented in the first sub-operation with the second input data implemented in the second sub-operation corresponding to the first sub-operation; and comparing the first output data output as the result of the first sub-operation with the second output data output as the result of the second sub-operation corresponding to the first sub-operation.

The comparing of the first data with the second data may include comparing the first data with the second data in bit units.

In a general aspect, a neural network apparatus includes one or more processors configured to provide test data to a first module that implements a first neural network based on a first framework, provide the test data to a second module that implements a second neural network having a same structure as the first neural network based on a second framework, obtain, from the first module, first data generated from the test data provided to the first module, obtain, from the first module, first data generated from the test data provided to the first module, obtain, from the second module, second data generated from the test data provided to the second module, and compare the first data with the second data.

The processor may be further configured to obtain first input data implemented in an operation of a layer of the first neural network and first output data generated based on the operation of the layer of the first neural network, and obtain second input data implemented in an operation of a layer of the second neural network and second output data generated based on the operation of the layer of the second neural network.

The processor may be further configured to compare the first input data implemented in the layer of the first neural network with the second input data implemented in the layer of the second neural network corresponding to the layer of the first neural network, and compare the first output data generated as the result of the operation of the layer of the first neural network with the second output data generated as the result of the operation of the layer of the second neural network corresponding to the layer of the first neural network.

The processor may be further configured to obtain first training parameters learned during the operation of the layer of the first neural network, and obtain second training parameters learned during the operation of the layer of the second neural network.

The processor may be further configured to compare the first training parameters learned during the operation of the layer of the first neural network with the second training parameters learned during the operation of the layer of the second neural network corresponding to the layer of the first neural network.

The processor may be further configured to obtain first input data implemented in a first sub-operation, which is an operation excluding an operation of a layer of the first neural network from among operations performed by the first module, and first output data output based on the first sub-operation, and obtain second input data implemented in a second sub-operation, which is an operation excluding an operation of a layer of the second neural network from among operations performed by the second module, and second output data output based on the second sub-operation.

Each of the first sub-operation and the second sub-operation may include at least one of a data augmentation operation, an optimization operation, a quantization operation, and a user operation.

The processor may be further configured to compare the first input data implemented in the first sub-operation with the second input data implemented in the second sub-operation corresponding to the first sub-operation, and compare the first output data output as the result of the first sub-operation with the second output data output as the result of the second sub-operation corresponding to the first sub-operation.

The processor may be further configured to compare the first data with the second data in bit units.

The apparatus may include a memory storing instructions that, when executed by the one or more processors, configure the one or more processors to perform the providing of the test data to the first module, the providing of the test data to the second module, the obtaining of the first data from the first module, the obtaining of the second data from the second module, and the comparing of the first data with the second data.

Other features and aspects will be apparent from the following detailed description, the drawings, and the claims.

### BRIEF DESCRIPTION OF DRAWINGS

FIG. 1 illustrates an example operation performed in a neural network, in accordance with one or more embodiments;

FIG. 2 illustrates an example architecture of a convolutional neural network, in accordance with one or more embodiments;

FIG. 3 illustrates an example forward propagation, backward propagation, weight update, and bias update, in accordance with one or more embodiments;

FIG. 4 illustrates an example data augmentation process, in accordance with one or more embodiments;

FIG. 5 illustrates an example of quantization process, in accordance with one or more embodiments;

FIG. 6 illustrates an example neural network implemented based on a framework, in accordance with one or more embodiments;

FIG. 7 is a flowchart illustrating an example method of verifying the training of a neural network between frameworks, in accordance with one or more embodiments;

FIG. 8 illustrates an example method of verifying the training of a neural network between frameworks, in accordance with one or more embodiments;

FIG. 9 illustrates an example method of verifying the training of a neural network between frameworks, in accordance with one or more embodiments;

FIG. 10 illustrates an example of comparing first data with second data, in accordance with one or more embodiments; and

FIG. 11 is a block diagram illustrating an example neural network device, in accordance with one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness, noting that omissions of features and their descriptions are also not intended to be admissions of their general knowledge.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains after an understanding of the disclosure of this application. Terms, such as those defined in commonly used dictionaries, are to be interpreted as having a meaning that is consistent with their meaning in the context of the relevant art and the disclosure of the present application, and are not to be interpreted in an idealized or overly formal sense unless expressly so defined herein.

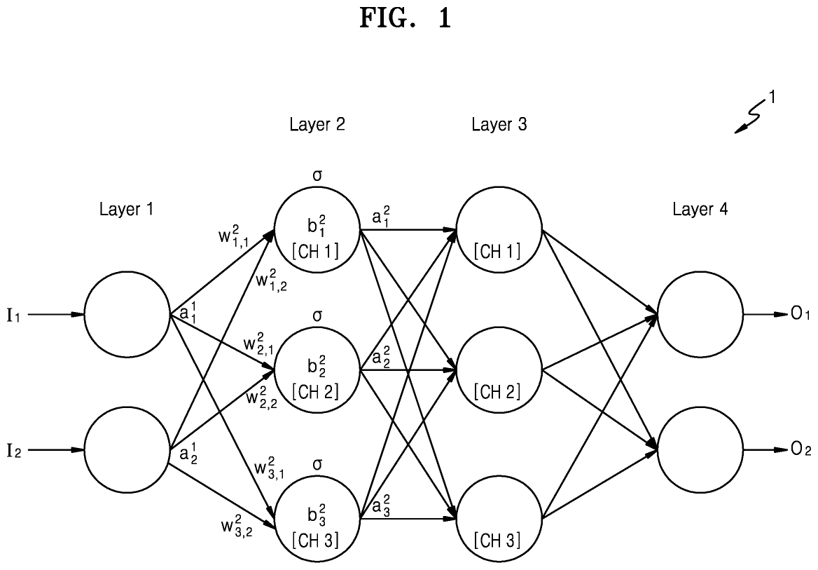

FIG. 1 illustrates an example operation performed in a neural network 1, in accordance with one or more embodiments.

Referring to FIG. 1, the neural network 1 has a structure including an input layer, to which input data is applied, a plurality of hidden layers for performing a neural network operation between the input layer and an output layer, and the output layer for outputting a result derived through prediction based on training and the input data. The neural network 1 may perform an operation (i.e., computations) based on received input data (e.g., I₁ and I₂) and may generate output data (e.g., O₁ and O₂) based on the result of performing the operation. The operations or computations may be implemented through processor-implemented neural network models, as specialized computational architectures that, after substantial training, may provide computationally intuitive mappings between input data or patterns and output data or patterns or pattern recognitions of input patterns. The trained capability of generating such mappings or performing such pattern recognitions may be referred to as a learning capability of the neural network. Such trained capabilities may also enable the specialized computational architecture to classify such an input pattern, or portion of the input pattern, as a member that belongs to one or more predetermined groups. Further, because of the specialized training, such specially trained neural network may thereby have a generalization capability of generating a relatively accurate or reliable output with respect to an input pattern that the neural network may not have been trained for, for example.

The neural network 1 may be a deep neural network (DNN) or n-layer neural network including two or more hidden layers. For example, as shown in FIG. 1, the neural network 1 may be a DNN including an input layer Layer 1, two hidden layers Layer 2 and Layer 3, and an output layer Layer 4. In an example, the input layer Layer 1 may correspond to, or may be referred to as, the lowest layer of the neural network 1, and the output layer Layer 4 may correspond to, or may be referred to as, the highest layer of the neural network. A layer order may be assigned and named or referred to sequentially from the output layer Layer 4, that is the highest layer, to the input layer Layer 1 that is the lowest layer. For example, a Hidden layer Layer 3 may correspond to a layer higher than a Hidden layer Layer 2 and the Input layer Layer 1, but is lower than the output layer Layer 4.

The DNN may be one or more of a fully connected network, a convolution neural network, a recurrent neural network, and the like, or may include different or overlapping neural network portions respectively with such full, convolutional, or recurrent connections, according to an algorithm used to process information. The neural network 1 may be configured to perform, as non-limiting examples, object classification, object recognition, voice recognition, and image recognition by mutually mapping input data and output data in a nonlinear relationship based on deep learning. Such deep learning is indicative of processor implemented machine learning schemes for solving issues, such as issues related to automated image or speech recognition from a data set, as non-limiting examples. Herein, it is noted that use of the term ‘may’ with respect to an example or embodiment, e.g., as to what an example or embodiment may include or implement, means that at least one example or embodiment exists where such a feature is included or implemented while all examples and embodiments are not limited thereto.

When the neural network 1 is implemented with the DNN architecture, the neural network 1 includes more layers that process valid information, and thus may process data sets of higher complexity than a neural network having a single layer. The neural network 1 is shown as including four layers, but this is only an example and the neural network 1 may include fewer or more layers, or may include fewer or more channels. That is, the neural network 1 may include layers of various structures that are different from those shown in FIG. 1.

Each of the layers in the neural network 1 may include a plurality of channels. Each of the channels may correspond to a plurality of artificial nodes, (or neurons), processing elements (PEs), units, or similar terms. For example, as shown in FIG. 1, the input layer Layer 1 may include two channels (nodes), and the hidden layers Layer 2 and Layer 3 may each include three channels. However, this is only an example, and each of the layers included in the neural network 1 may include various numbers of channels (nodes). However, such reference to “neurons” is not intended to impart any relatedness with respect to how the neural network architecture computationally maps or thereby intuitively recognizes information, and how a human's neurons operate. In other words, the term “neuron” is merely a term of art referring to the hardware implemented nodes of a neural network, and will have a same meaning as a node of the neural network.

Channels included in each of the layers of the neural network 1 may be connected to each other to process data. For example, one channel may receive data from other channels and compute the data and may output a computation result to other channels.

The input and output of each of the channels may respectively be referred to as input activation and output activation. That is, the activation may be an output of one channel and may also be a parameter corresponding to input of channels included in a next or higher layer. Each of the channels may determine its own activation based on activations, which are received from channels included in a previous layer, a weight, and a bias. The weight is a parameter used to calculate the output activation in each channel, and may be a value assigned to a connection relationship between the channels. The training of a neural network may mean determining and updating weights and biases between layers or between a plurality of nodes (or neurons) that belong to different layers of adjacent layers. For example, the weight and biases of a layer structure or between layers or neurons may be collectively referred to as connectivity of a neural network. Accordingly, the training of a neural network may denote establishing and training connectivity.

Each of the channels may be processed by a computational unit or processing element that receives an input and outputs an output activation, and the input-output of each of the channels may be mapped. For example, when f is an activation function, wⱼₖⁱ is a weight from a k-th channel included in an (i−1)-th layer to a j-th channel included in an i-th layer, is a bias of the j-th channel included in the i-th layer, and aⱼⁱ is the activation of the j-th channel included in the i-th layer, the activation aⱼⁱ may be calculated using Equation 1 below as follows.

$${a}_{j}^{i} = σ ( {\sum }_{k} ( {w}_{jk}^{i} \times {a}_{k}^{- 1} ) + {b}_{j}^{i} ) \qquad Equation 1$$

As shown in FIG. 1, the activation of a first channel CH 1 of a second layer (i.e., the hidden layer Layer2) may be represented by a₁². a₁² may have a value of a₁²=σ(w_{1,1}²×a₁¹+w_{1,2}²×a₂¹+b₁²) according to Equation 1. However, Equation 1 described above is only an example for describing activation, weight, and bias used for processing data in the neural network 1, and is not limited thereto. The activation may be a value obtained by passing a weighted sum of activations received from a previous or lower layer to an activation function such as a sigmoid function or a rectified linear unit (ReLU) function.

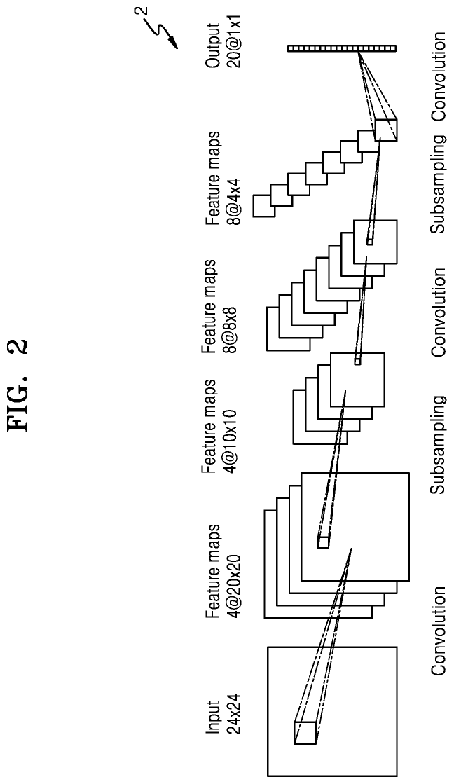

FIG. 2 illustrates an example of the architecture of a convolutional neural network, in accordance with one or more embodiments.

Referring to FIG. 2, some convolution layers of a convolutional neural network 2 are illustrated, but the convolutional neural network 2 may further include a pooling layer, a fully connected layer, or the like, in addition to the illustrated convolution layers.

The convolutional neural network 2 may be embodied as an architecture having a plurality of layers including an input image, feature maps, and an output. In the convolutional neural network 2, a convolution operation is performed on the input image with a filter referred to as a kernel, and as a result, the feature maps are output. The convolution operation is performed again on the output feature maps as input feature maps, with a kernel, and new feature maps are output. When the convolution operation is repeatedly performed as such, a recognition result with respect to features of the input image may be finally output through the convolutional neural network 2.

For example, when an input image having a 24×24 pixel size is input to the convolutional neural network 2 of FIG. 2, the input image may be output as feature maps of four channels each having a 20×20 pixel size, through a convolution operation with a kernel. Then, sizes of the 20×20 feature maps may be reduced through repeated convolution operations with the kernel, and finally, features each having a 1×1 pixel size may be output. In the convolutional neural network 2, a convolution operation and a sub-sampling (or pooling) operation may be repeatedly performed in several layers so as to filter and output robust features, which may represent the entire input image, from the input image, and derive the recognition result of the input image through final features that are output.

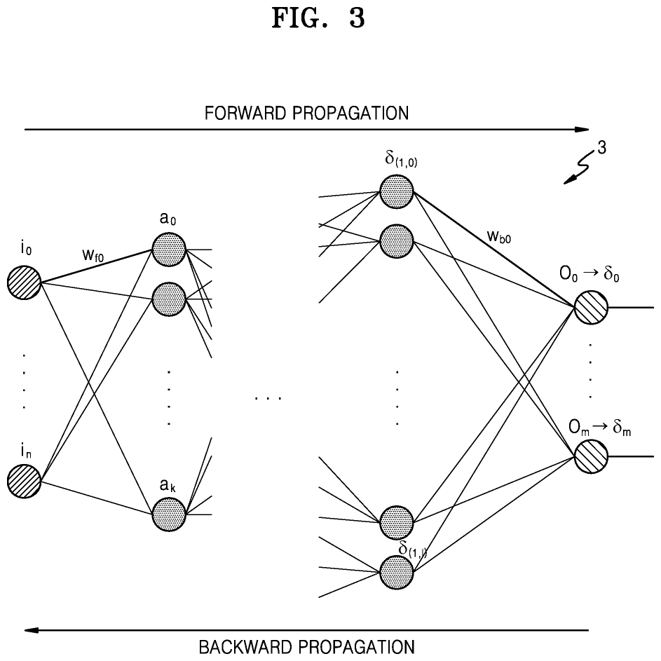

FIG. 3 illustrates examples of forward propagation, backward propagation, weight update, and bias update.

FIG. 3 illustrates an example of a neural network 3 including a plurality of layers. According to the neural network 3, the final output activations o₀, . . . oₘ may be generated after initial input activations i₀, . . . , iₙ are operation-performed through at least one hidden layer. As a non-limiting example, the operation may include a process of performing a linear operation on the input activation, a weight, and a bias in each layer, and generating the output activation by applying a ReLU activation function to the result of the linear operation.

Forward propagation may refer to a process in which the operation proceeds in a direction in which the final output activations o₀, . . . , oₘ are generated based on the initial input activations i₀, . . . , iₙ. For example, the initial input activations i₀, . . . , iₙ may be operation-performed with weights and biases to generate intermediate output activations a₀, . . . , aₖ. The intermediate output activations a₀, . . . aₖ may be the input activations of a next process, and the above operation may be performed again. Through this process, the final output activations o₀, . . . , oₙ, may be generated.

When the final output activations o₀, . . . , oₙ, are generated, the final output activations o₀, . . . , oₘ may be compared with the expected result to generate a loss δ that is a value of a loss function. The training of the neural network 3 may be performed in the direction of reducing the loss δ.

In order for the loss δ to be small, the activations used in the previously-performed intermediate operations may have to be updated as the final losses δ₀, . . . , δₘ propagate in the opposite direction of the forward propagation direction (i.e., backward propagation). For example, the final losses δ₀, . . . , δₘ may be operation-performed with weights to generate intermediate losses δ_{(1,0)}, . . . , δ(_{1,l}). The intermediate losses δ_{(1,0)}, . . . , δ_{(1,l)} may be the input for generating the intermediate losses of the next layer, and the above operation may be performed again. Through this process, the loss δ may propagate in the opposite direction of the forward propagation direction, and an activation gradient used to update the activations may be calculated. However, a kernel used in backward propagation may be obtained by rearranging a kernel of forward propagation.

As described above, when backward propagation is performed on all layers of the neural network 3, the weight and the bias may be updated based on a result of backward propagation. Specifically, the gradient of weight used to update the weight may be calculated by using the activation gradient calculated according to the backward propagation. Through the update of the weight and the bias, the neural network 3 may be trained.

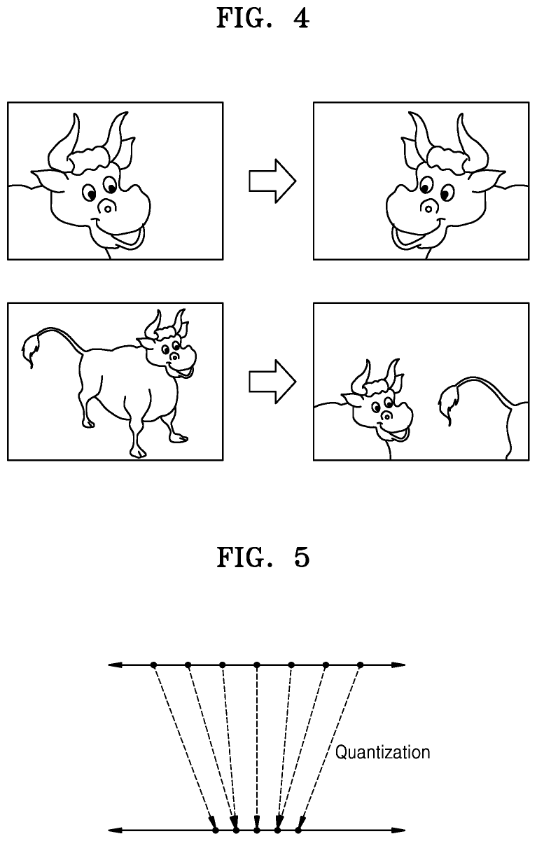

FIG. 4 illustrates an example of data augmentation, in accordance with one or more embodiments.

The training of a neural network may be described as tuning training parameters such as weights and biases, and specifically, determining and updating weights and biases between layers or between a plurality of nodes that belong to different layers of adjacent layers. The neural network may include a greater number of training parameters as a task to be processed becomes more complicated. For example, in implementing a task of classifying images by category, the neural network may include about 1 billion training parameters, and in implementing a task of translating languages, the neural network may include about 4 billion training parameters.

The training parameters may be learned so that the neural network outputs desired features for provided test data. The more the neural network includes a greater number of training parameters, the more test data may be needed. When there is not enough test data to train the neural network with the training parameters, data augmentation may be used.

Data augmentation may be used so that the neural network may be trained to output desired features even for input data obtained by modification of test data. For example, when a neural network is trained based on images in which a cow looks to the right and images in which a cat looks to the left, the neural network may misclassify an image, in which a cow looks to the left, as a cat because the neural network has not been trained to differentiate an image in which a cow looks to the left. By using data augmentation to include, in test data, images in which a cow looks to the left, the neural network may be trained to classify an image, in which a cow looks to the left, as a cow.

Data augmentation may include, as non-limiting examples, the process of flipping an image, the process of rotating an image, the process of scaling an image, the process of cropping an image, the process of translating an image, and the process of adding noise to an image, and the like. Data augmentation may also include various processes that may transform test data.

FIG. 5 illustrates an example of quantization, in accordance with one or more embodiments.

Input data provided to the neural network may include parameters in a floating-point format. Since the parameters in the floating-point format contain more information than parameters in a fixed-point format, performing an operation using the parameters in the floating-point format may obtain a more accurate operation result than performing an operation using the parameters in the fixed-point format.

The neural network may need a large amount of computations to extract final features corresponding to input data. A neural network device that implements the neural network may be a device having limited resources, such as, as non-limiting examples, a personal computer (PC), a server, a mobile device, and the like, and may correspond to, or be an apparatus provided in, an autonomous vehicle, robotics, a smartphone, a tablet device, an augmented reality (AR) device, an Internet of things (IoT) device, or the like. Thus, a reduction in resources needed to process input data may be beneficial.

Quantization may mean converting parameters in the floating-point format to parameters in the fixed-point format or converting parameters in the fixed-point format, which are output from a convolution operation, back to parameters in the fixed-point format.

Quantization may reduce the amount of computations in the neural network. By quantizing parameters into bits of a length less than the original bit length, the amount of computations needed for the processing of the parameters may be reduced even if the accuracy is somewhat reduced. As a quantization method, various methods such as a linear quantization method and a log quantization method may be used.

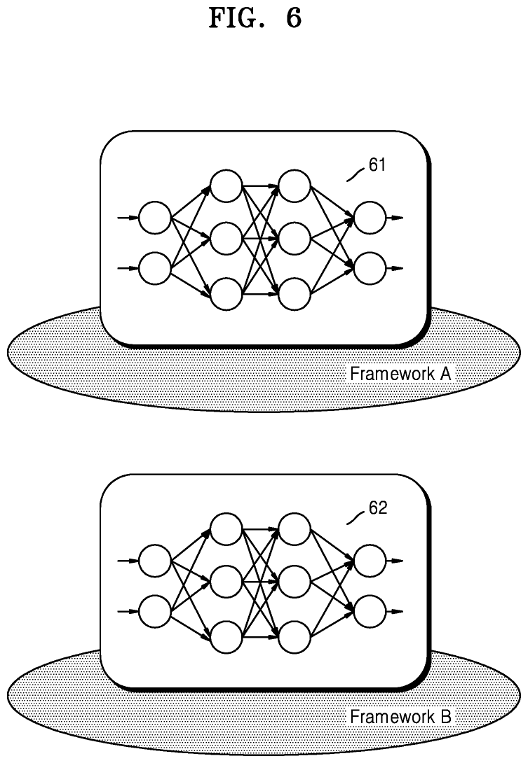

FIG. 6 illustrates an example neural network implemented based on a framework, in accordance with one or more embodiments.

The framework may provide various processing functions, such as performing data augmentation on input data provided to the neural network, generating the neural network, training the neural network, quantizing parameters of the neural network, or performing optimization to tune training parameters of the network.

In an example, the framework may include various modules that perform processing functions. As non-limiting examples, the framework may include a module that performs a convolution operation, a module that performs a linear operation, a module that performs data augmentation, a module that performs optimization, a module that performs quantization, a module that performs a user operation, and the like.

The module that performs the convolution operation and the module that performs the linear operation may correspond to a layer of the neural network. For example, the module that performs the convolution operation may correspond to a convolution layer, and the module that performs the linear operation may correspond to a fully connected layer.

The neural networks may be implemented based on various frameworks. The various frameworks may include, as non-limiting examples, deep learning frameworks such as Theano, Tensorflow, Caffe, Keras, and pyTorch.

Depending on the type of a framework implementing the neural network, there may be a difference in training parameters generated during the training process of the neural network. For example, training parameters of a neural network 61 implemented based on a framework A may be different from training parameters of a neural network 62 implemented based on a framework B.

Due to the difference in training parameters between the frameworks, a feature map generated by a layer and features finally outputted by the neural network may be changed when the trained neural network is operated. Therefore, in order to analyze and compensate for a difference between neural networks implemented based on different frameworks, a method of verifying the training of a neural network between frameworks is required.

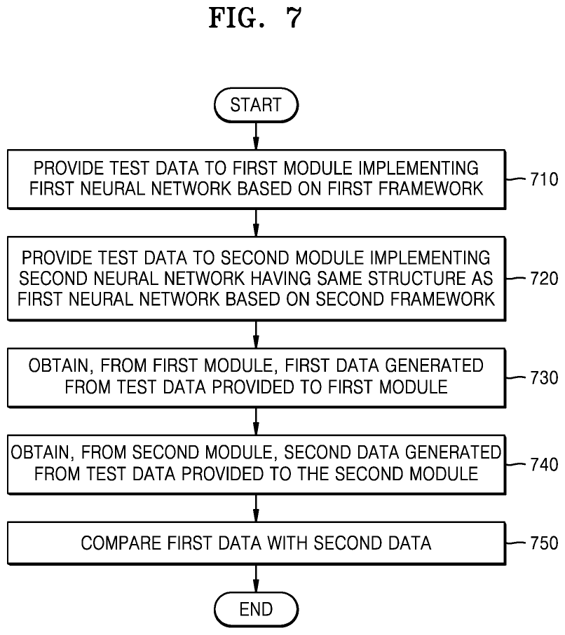

FIG. 7 is a flowchart illustrating an example method of verifying the training of a neural network between frameworks, in accordance with one or more embodiments. The operations in FIG. 7 may be performed in the sequence and manner as shown, although the order of some operations may be changed or some of the operations omitted without departing from the spirit and scope of the illustrative examples described. Many of the operations shown in FIG. 7 may be performed in parallel or concurrently. One or more blocks of FIG. 7, and combinations of the blocks, can be implemented by special purpose hardware-based computer that perform the specified functions, or combinations of special purpose hardware and computer instructions. In addition to the description of FIG. 7 below, the descriptions of FIGS. 1-6 are also applicable to FIG. 7, and are incorporated herein by reference. Thus, the above description may not be repeated here.

Referring to FIG. 7, the method of verifying the training of a neural network between frameworks may include operations processed in time series in a neural network device 1100 illustrated in FIG. 11. In addition, descriptions given below may be applied to the neural network device 1100.

In operation 710, a processor 1120 of the neural network device 1100 may provide test data to a first module implementing a first neural network based on a first framework.

In an example, the first framework may be a framework that is different from a second framework to be described below, and may provide various processing functions used to train the neural network.

The first module may perform an operation of a layer of the first neural network. In a non-limiting example, the layer of the first neural network may be a convolution layer, a pooling layer, a flatten layer, a fully connected layer, or the like, but is not limited thereto. For example, the first module may perform a convolution operation as an operation of a convolution layer, may perform a pulling operation as an operation of a pooling layer, may change a dimension as an operation of a flatten layer, and may perform a linear operation as an operation of a fully connected layer, and similar functions.

The first module may perform various sub-operations for training the first neural network in addition to the operation of the layer of the first neural network. For example, the sub-operations may include a quantization operation that converts parameters in a floating point format to parameters in the fixed point format or converts parameters in the fixed point format, which are output from a convolution operation, back to parameters in the fixed point format, an optimization operation for reducing loss, a data augmentation operation for performing data augmentation on test data, a user operation defined by a user, and the like, but are not limited thereto.

The test data may be input data provided to the first neural network to train the first neural network with training parameters according to a task which the first neural network intends to perform. For example, in the example of a neural network that is implemented for speech recognition, the test data may include voice data, and in the example of a neural network that is implemented for image classification, the test data may include image data.

In operation 720, the processor 1120 of the neural network device 1100 may provide test data to a second module that implements a second neural network that may have the same structure as the first neural network based on a second framework.

The second module may differ from the first module only in that the second module is based on the second framework and the first module is based on the first framework. The second module may be configured to implement a second neural network having the same structure as the first neural network. The second module may perform operations and sub-operations of a layer in the first module.

The processor 1120 of the neural network device 1100 may provide the second module with test data that is the same as the test data provided to the first module.

In operation 730, the processor 1120 of the neural network device 1100 may obtain, from the first module, first data generated from the test data provided to the first module.

The first data may include first input data provided for use in an operation of a layer of the first neural network, first output data generated as a result of the operation of the layer of the first neural network, and first training parameters learned during the operation of the layer of the first neural network. In an example, the first input data and the first output data may include, as non-limiting examples, a feature map, an activation gradient, a weight gradient, and the like, and the first training parameters may include a weight, a bias, and the like.

In operation 740, the processor 1120 of the neural network device 1100 may obtain, from the second module, second data generated from the test data provided to the second module.

The second data may include second input data provided for use in an operation of a layer of the second neural network, second output data generated as a result of the operation of the layer of the second neural network, and second training parameters learned during the operation of the layer of the second neural network. In an example, the second input data and the second output data may include, as non-limiting examples, a feature map, an activation gradient, a weight gradient, and the like, and the second training parameters may include a weight, a bias, and the like.

In operation 750, the processor 1120 of the neural network device 1100 may compare the first data with the second data.

The processor 1120 may compare the first data with the second data corresponding to the first data. Specifically, the processor 1120 may compare the first input data of the first module with the second input data of the second module, compare the first output data with the second output data, and compare the first training parameters with the second training parameters. In an example, the processor 1120 may compare first output data generated as a result of quantizing the test data provided to the first module with second output data generated as a result of quantizing the test data provided to the second module. In another example, the processor 1120 may compare first training parameters learned during an operation of an n-th convolution layer of the first neural network with second training parameters learned during an operation of an n-th convolution layer of the second neural network.

The processor 1120 may compare the first data with the second data in bit units. The processor 1120 may generate comparison result data by comparing the first data with the second data in bit units. For example, the processor 1120 may generate n-bit comparison result data by performing an XOR operation on n-bit first data and n-bit second data in bit units.

Alternatively, the processor 1120 may compare the first data with the second data based on a check sum. For example, the processor 1120 may add all bytes of the first data to obtain a first checksum byte, may add all bytes of the second data to obtain a second checksum byte, and may compare the first checksum byte with the second checksum byte.

The processor 1120 may verify the training of the neural network between frameworks by comparing, for each operation, the training processes of the first neural network based on the first framework and the training processes of the second neural network based on the second framework.

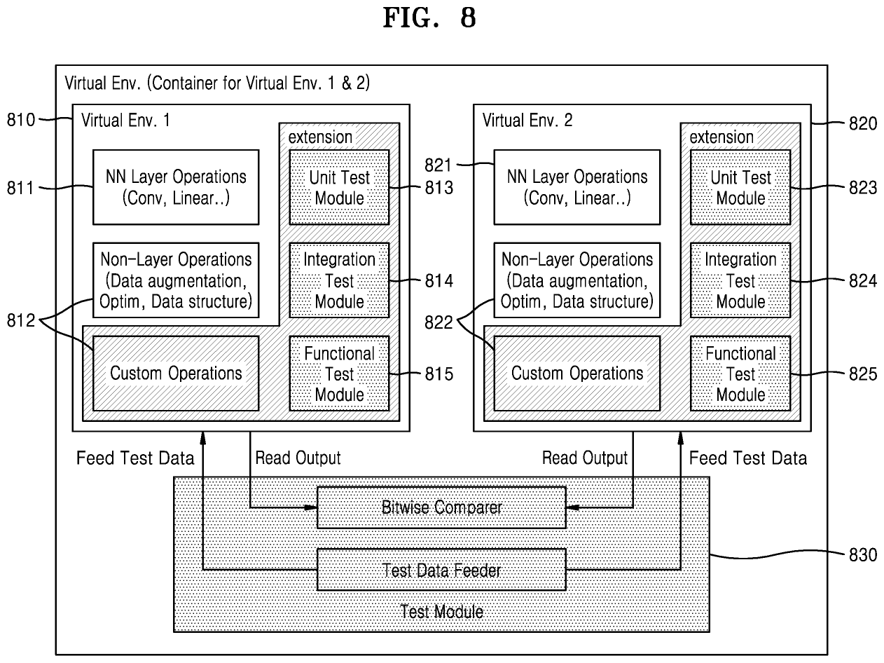

FIG. 8 illustrates an example method of verifying the training of a neural network between frameworks, in accordance with one or more embodiments.

A first module 810 may implement a first neural network based on a first framework, and a second module 820 may implement a second neural network based on a second framework that is different from the first framework. A test module 830 may compare data generated by the first module 810 with data generated by the second module 820. The test module 830 may be operated or controlled by the processor 1120 of the neural network device 1100. The first module 810 and the second module 820 may be operated or controlled by the processor 1120 of the neural network device 1100, like the test module 830, or may be operated or controlled by a processor of another neural network device.

The first module 810 may include a function of performing an operation 811 of a layer of the first neural network. In a non-limiting example, the first module 810 may perform a convolution operation corresponding to a convolution layer, or may perform a linear operation corresponding to a fully connected layer, and similar operations.

The first module 810 may perform a first sub-operation 812. In this example, the first sub-operation 812 may be an operation that excludes the operation 811 of the layer from among operations for training the first neural network. For example, the first sub-operation may be a data augmentation operation, an optimization operation, a quantization operation, or a user operation, but is not limited thereto.

The first module 810 may include a unit test module 813, a functional test module 815, and an integration test module 814.

The unit test module 813 may obtain first data generated by the first module 810 and providing the first data to the test module 830. Specifically, the unit test module 813 may obtain first input data provided for use in an operation of a layer of the first neural network, first output data generated as a result of the operation of the layer of the first neural network, and first training parameters learned during the operation of the layer of the first neural network.

For example, the unit test module 813 may obtain, as examples, a feature map, an activation gradient, or a weight gradient as the first input data and the first output data, and obtain a weight or a bias as the first training parameters.

The unit test module 813 also may obtain first input data provided for use in a first sub-operation and first output data output as a result of the first-sub operation and providing the obtained first input data and first output data to the test module 830.

For example, the unit test module 813 may obtain parameters of a floating-point format as first input data, and obtain parameters of a fixed-point format, which is obtained by quantization of the parameters of the floating-point format, as first output data.

The functional test module 815 may obtain features finally output by a neural network implemented by the first module 810, and provide the obtained features to the test module 830.

The integration test module 814 may determine whether the first module 810 operates normally.

The second module 820 may differ from the first module 810 only in that the second module 820 operates based on the second framework, and may include the same functions as the first module 810. In an example, the second module 820 may perform an operation 821 of a layer of the second neural network, and may perform a second sub-operation 822 corresponding to the first-sub operation 812, and the like.

The second module 820 may include a unit test module 823, an integration test module 824, and a functional test module 825, similar to the first module 810. The unit test module 823, the integration test module 824, and the functional test module 825 of the second module 820 may include functions that are the same as the functions of the unit test module 813, the integration test module 814, and the functional test module 815 of the first module 810, respectively.

The test module 830 may provide test data to the first module 810 and the second module 820. In an example, the test module 830 may provide the same test data to the first module 810 and the second module 820. However, this is only an example, and the test module 830 may provide different test data to the first module 810 and the second module 820.

The test module 830 may compare the first data generated by the first module 810 with second data generated by the second module 820. For example, the test module 830 may compare the first data with the second data in bit units.

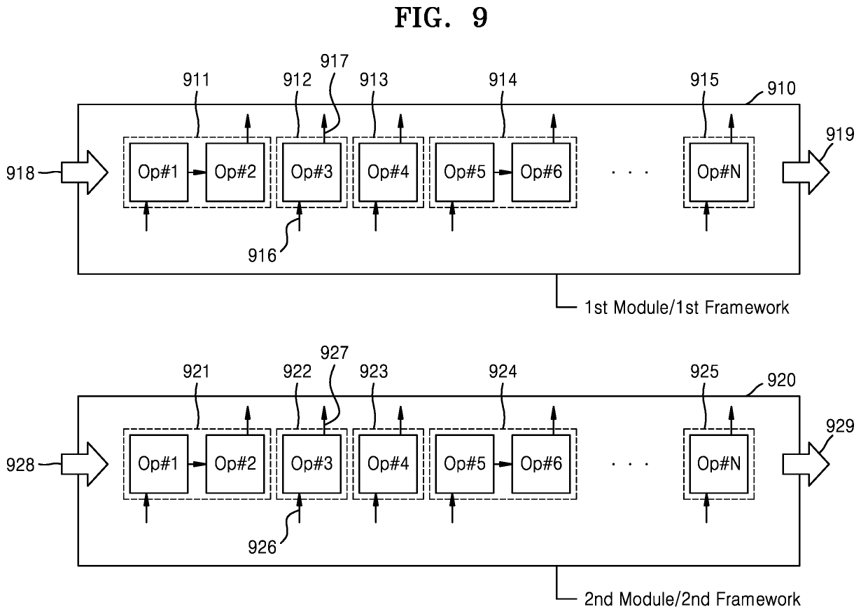

FIG. 9 illustrates an example method of verifying the training of a neural network between frameworks, in accordance with one or more embodiments.

The processor 1120 of the neural network device 1100 may provide test data 918 to a first module 910 that implements a first neural network which is based on a first framework. The processor 1120 may provide the same test data 918 as test data 928 to a second module 920 that implements a second neural network that may have the same structure as the first neural network which is based on a second framework.

The first module 910 may include sub-modules. As non-limiting examples, the first module 910 may include, as sub-modules, a quantization module 911 that performs quantization, a convolution module 912 that performs an operation of a convolution layer, a user module 913 that performs a user operation, an optimization module 914 that performs an optimization operation, and a linear module 915 that performs an operation of a fully connected layer, as only examples. The first module 910 may further include a data augmentation module that performs data augmentation, a pooling module that performs an operation of a pooling layer, and the like. The sub-modules in the first module 910 are not limited to the examples listed herein.

The second module 920 may include sub-modules corresponding to the sub-modules of the first module 910. For example, the second module 920 may include, as sub-modules, a quantization module 921, a convolution module 922, a user module 923, an optimization module 924, and a linear module 925.

The processor 1120 may obtain first data generated from the test data 918 provided to the first module 910 and second data generated from the test data 928 provided to the second module 920, and may compare the first data with the second data.

The first data may include, as non-limiting examples, data input to the sub-modules of the first module 910, data output by the sub-modules of the first module 910, training parameters learned in the first neural network, and features 919 finally output by the first neural network.

Similarly, the second data may include, as non-limiting examples, data input to the sub-modules of the second module 920, data output by the sub-modules of the second module 920, training parameters learned in the second neural network, and features 929 finally output by the second neural network.

The processor 1120 may compare the first data with the second data for each sub-module. In an example, the processor 1120 may compare a feature map 916 input to the convolution module 912 of the first module 910 with a feature map 926 input to the convolution module 922 of the second module 920. In another example, the processor 1120 may compare a feature map 917 output from the convolution module 912 of the first module 910 with a feature map 927 output from the convolution module 922 of the second module 920. In another example, the processor 1120 may compare training parameters learned in the convolution module 912 of the first module 910 with training parameters learned in the convolution module 922 of the second module 920. In another example, the processor 1120 may compare the features 919 finally output by the first neural network implemented by the first module 910 with the features 929 finally output by the second neural network implemented by the second module 920.

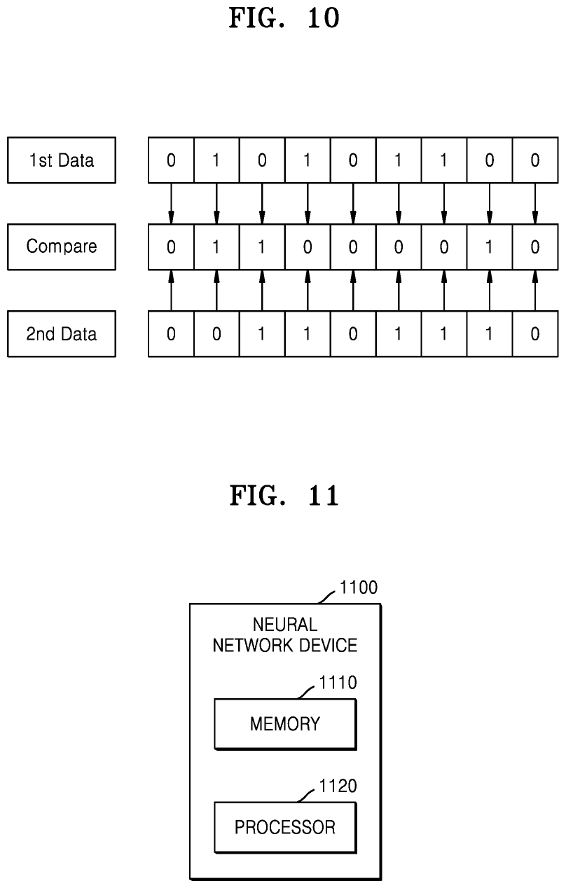

FIG. 10 illustrates an example of comparing the first data with the second data, in accordance with one or more embodiments.

The processor 1120 may compare the first data output from the first module 910 with the second data output from the second module 920, in bit units. The processor 1120 may generate comparison resultant data by comparing the first data with the second data in bit units. In an example, the processor 1120 may generate n-bit comparison result data by performing an XOR operation on n-bit first data and n-bit second data in bit units. In another example, the processor 1120 may generate n-bit intermediate comparison data by performing an XOR operation on n-bit first data and n-bit second data in bit units, and may generate m-bit comparison result data by calculating a ratio of the number of bits having a value of 1 to the total number of bits of the n-bit intermediate comparison data.

FIG. 11 is a block diagram illustrating an example of a neural network device 1100. In an example, the neural network apparatus 1100 may further store instructions, e.g., in memory 1110, which when executed by the processor 1120 configure the processor 1120 to implement one or more or any combination of operations herein. The processor 1120 and the memory 1110 may be respectively representative of one or more processors 1120 and one or more memories 1110.

Referring to FIG. 11, the neural network device 1100 includes the memory 1110 and the processor 1120. Additionally, although not shown in FIG. 11, the neural network device 1100 may be connected to an external memory. In the neural network device 1100 shown in FIG. 11, only components related to the present examples are illustrated. Thus, the neural network device 1100 may further include other general-purpose components in addition to the components shown in FIG. 11.

The neural network device 1100 may be a device implementing the neural network described above with reference to FIGS. 1 and 2. For example, the neural network device 1100 may be implemented with various types of devices, such as a personal computer (PC), a server, a mobile device, and an embedded device. In more detail, the neural network device 1100 may be implemented in a smart phone, a tablet device, an augmented reality (AR) device, an IoT device, an autonomous vehicle, robotics, a medical device, or the like, which performs voice recognition, image recognition, and image classification using a neural network, but is not limited thereto. Furthermore, the neural network device 1100 may correspond to a dedicated hardware accelerator mounted on the device described above, or may be a hardware accelerator, such as a neural processing unit (NPU), which is a dedicated module for driving a neural network, a tensor processing unit (TPU), or a neural engine.

The memory 1110 is hardware for storing various pieces of data processed by the neural network device 1100. For example, the memory 1110 may store data processed by the neural network device 1100 and data to be processed by the neural network device 1100. Also, the memory 1110 may store applications, drivers, etc. to be driven by the neural network device 1100.

The memory 1730 may include at least one of volatile memory or nonvolatile memory. The nonvolatile memory may include read only memory (ROM), programmable ROM (PROM), electrically programmable ROM (EPROM), electrically erasable and programmable ROM (EEPROM), flash memory, phase-change RAM (PRAM), magnetic RAM (MRAM), resistive RAM (RRAM), ferroelectric RAM (FRAM), and the like. The volatile memory may include dynamic RAM (DRAM), static RAM (SRAM), synchronous DRAM (SDRAM), phase-change RAM (PRAM), magnetic RAM (MRAM), resistive RAM (RRAM), ferroelectric RAM (FeRAM), and the like. Furthermore, the memory 120 may include at least one of hard disk drives (HDDs), solid state drive (SSDs), compact flash (CF) cards, secure digital (SD) cards, micro secure digital (Micro-SD) cards, mini secure digital (Mini-SD) cards, extreme digital (xD) cards, or Memory Sticks.

The processor 1120 is a hardware configuration for performing general control functions to control overall operations for driving a neural network in the neural network device 1100. For example, the processor 1120 generally controls the neural network device 1100 by executing programs stored in the memory 1110. The processor 1710 may be implemented with a central processing unit (CPU), a graphics processing unit (GPU), an application processor (AP), etc. included in the neural network device 1100, but is not limited thereto.

The processor 1120 reads/writes data (e.g., image data, feature map data, kernel data, etc.) from/to the memory 1110, and operates a neural network by using the read/written data. When the neural network is operated, the processor 1120 drives processing units included therein to repeatedly perform operations between an input feature map for generating data about an output feature map and a kernel. In this case, the amount of computations may be determined depending on various factors such as the number of channels of the input feature map, the number of channels of the kernel, the size of the input feature map, the size of the kernel, and the precision of values.

For example, each of the processing units may include logic circuitry for computations. In detail, the processing unit may include an operator (i.e., a computing element) implemented by a combination of a multiplier, an adder, and an accumulator. The multiplier may be implemented with a combination of multiple sub-multipliers, and the adder may be implemented with a combination of multiple sub-adders.

The processor 1120 may further include an on-chip memory, which functions as a cache or buffer to process operations, and a dispatcher for dispatching various operands such as pixel values of an input feature map or weight values of filters. For example, the dispatcher dispatches, to the on-chip memory, operands such as pixel values and weight values required for an operation to be performed by the processing unit from data stored in the memory 1110. Then, the dispatcher dispatches the operands dispatched in the on-chip memory again to the processing unit for operation.

The neural network apparatuses, the neural network device 1100, processor 1120, memory 1110, and other apparatuses, units, modules, devices, and other components described herein and with respect to FIGS. 1-11, are implemented as, and by, hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods that perform the operations described in this application and illustrated in FIGS. 1-8 are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller, e.g., as respective operations of processor implemented methods. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computers using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A processor-implemented method comprising:
providing test data to a first module that implements a first neural network based on a first framework;
providing the test data to a second module that implements a second neural network having a same structure as the first neural network based on a second framework;
obtaining, from the first module, first data generated from the test data provided to the first module;
obtaining, from the second module, second data generated from the test data provided to the second module; and
comparing the first data with the second data.

2. The method of claim 1, wherein the obtaining of the first data from the first module comprises:
obtaining first input data implemented in an operation of a layer of the first neural network and first output data generated based on the operation of the layer of the first neural network, and
the obtaining of the second data from the second module comprises:
obtaining second input data implemented in an operation of a layer of the second neural network and second output data generated based on the operation of the layer of the second neural network.

3. The method of claim 2, wherein the comparing of the first data with the second data comprises:
comparing the first input data implemented in the layer of the first neural network with the second input data implemented in the layer of the second neural network corresponding to the layer of the first neural network; and
comparing the first output data generated as the result of the operation of the layer of the first neural network with the second output data generated as the result of the operation of the layer of the second neural network corresponding to the layer of the first neural network.

4. The method of claim 2, wherein the obtaining the first data from the first module comprises:
obtaining first training parameters learned during the operation of the layer of the first neural network, and
the obtaining the second data from the second module comprises:
obtaining second training parameters learned during the operation of the layer of the second neural network.

5. The method of claim 4, wherein the comparing of the first data with the second data comprises comparing the first training parameters learned during the operation of the layer of the first neural network, with the second training parameters learned during the operation of the layer of the second neural network corresponding to the layer of the first neural network.

6. The method of claim 1, wherein the obtaining the first data from the first module comprises:
obtaining first input data implemented in a first sub-operation, which is an operation excluding an operation of a layer of the first neural network from among operations performed by the first module, and first output data output based on the first sub-operation, and
the obtaining the second data from the second module comprises:
obtaining second input data implemented in a second sub-operation, which is an operation excluding an operation of a layer of the second neural network from among operations performed by the second module, and second output data output based on the second sub-operation.

7. The method of claim 6, wherein each of the first sub-operation and the second sub-operation comprises at least one of a data augmentation operation, an optimization operation, a quantization operation, and a user operation.

8. The method of claim 6, wherein the comparing of the first data with the second data comprises:
comparing the first input data implemented in the first sub-operation with the second input data implemented in the second sub-operation corresponding to the first sub-operation; and
comparing the first output data output as the result of the first sub-operation with the second output data output as the result of the second sub-operation corresponding to the first sub-operation.

9. The method of claim 1, wherein the comparing of the first data with the second data comprises comparing the first data with the second data in bit units.

10. A non-transitory computer-readable storage medium storing instructions that, when executed by a processor, cause the processor to perform the method of claim 1.

11. A neural network apparatus comprising:
one or more processors configured to:
provide test data to a first module that implements a first neural network based on a first framework,
provide the test data to a second module that implements a second neural network having a same structure as the first neural network based on a second framework,
obtain, from the first module, first data generated from the test data provided to the first module,
obtain, from the second module, second data generated from the test data provided to the second module, and
compare the first data with the second data.

12. The apparatus of claim 11, wherein the processor is further configured to
obtain first input data implemented in an operation of a layer of the first neural network and first output data generated based on the operation of the layer of the first neural network, and
obtain second input data implemented in an operation of a layer of the second neural network and second output data generated based on the operation of the layer of the second neural network.

13. The apparatus of claim 12, wherein the processor is further configured to
compare the first input data implemented in the layer of the first neural network with the second input data implemented in the layer of the second neural network corresponding to the layer of the first neural network, and
compare the first output data generated as the result of the operation of the layer of the first neural network with the second output data generated as the result of the operation of the layer of the second neural network corresponding to the layer of the first neural network.

14. The apparatus of claim 12, wherein the processor is further configured to
obtain first training parameters learned during the operation of the layer of the first neural network, and
obtain second training parameters learned during the operation of the layer of the second neural network.

15. The apparatus of claim 14, wherein the processor is further configured to
compare the first training parameters learned during the operation of the layer of the first neural network with the second training parameters learned during the operation of the layer of the second neural network corresponding to the layer of the first neural network.

16. The apparatus of claim 11, wherein the processor is further configured to
obtain first input data implemented in a first sub-operation, which is an operation excluding an operation of a layer of the first neural network from among operations performed by the first module, and first output data output based on the first sub-operation, and
obtain second input data implemented in a second sub-operation, which is an operation excluding an operation of a layer of the second neural network from among operations performed by the second module, and second output data output based on the second sub-operation.

17. The apparatus of claim 16, wherein each of the first sub-operation and the second sub-operation comprises at least one of a data augmentation operation, an optimization operation, a quantization operation, and a user operation.

18. The apparatus of claim 16, wherein the processor is further configured to
compare the first input data implemented in the first sub-operation with the second input data implemented in the second sub-operation corresponding to the first sub-operation, and
compare the first output data output as the result of the first sub-operation with the second output data output as the result of the second sub-operation corresponding to the first sub-operation.

19. The apparatus of claim 11, wherein the processor is further configured to compare the first data with the second data in bit units.

20. The apparatus of claim 11, further comprising a memory storing instructions that, when executed by the one or more processors, configure the one or more processors to perform the providing of the test data to the first module, the providing of the test data to the second module, the obtaining of the first data from the first module, the obtaining of the second data from the second module, and the comparing of the first data with the second data.
